(19) United States
(12) Patent Application Publication
(10) Pub. No.: US 2004/0080727 A1
(43) Pub. Date: Apr. 29, 2004

(54) EUV exposure apparatus with cooling device to prevent overheat of electromagnetic motor in vacuum

(75) Inventor: Keiji Emoto, Tochigi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/674,359

(22) Filed: Oct. 1, 2003

(30) Foreign Application Priority Data
Oct. 23, 2002 (JP) 2002-308058

(51) Int. Cl. G03B 27/52

(52) U.S. Cl. 355/30; 355/53; 355/72; 355/75; 355/76

(57) ABSTRACT

An EUV exposure apparatus is provided in which coils of an electromagnetic motor for driving a stage are kept from overheat damage as a result of heat generated by the coils themselves. In an EUV exposure apparatus for exposing a mask pattern to a wafer in a vacuum, the apparatus comprises an electromagnetic motor disposed in the vacuum and driving at least one of a mask stage and a wafer stage, and a cooling unit for cooling the electromagnetic motor to prevent overheat damage of the electromagnetic motor caused by heat generated by the electromagnetic motor.

### BACKGROUND OF THE INVENTION

1. Field of the Invention

The present invention relates to an EUV exposure apparatus for projecting and exposing a pattern on a mask as an original plate to a semiconductor wafer as a substrate in a vacuum.

2. Description of the Related Art

In manufacturing devices on which fine patterns are formed, such as semiconductor devices, e.g., semiconductor integrated circuits, micromachines and thin-film magnetic heads, a desired pattern is formed on a substrate by illuminating a light (visible light or ultraviolet light), an X-ray, etc. to the substrate, i.e., an object onto which the pattern is to be transferred, through a mask which serves as an original plate.

When manufacturing a semiconductor integrated circuit, a mask corresponding to a desired circuit pattern is disposed over a semiconductor wafer having a resist coated on the wafer surface. A light or an X-ray is illuminated to the semiconductor wafer through the mask to selectively expose the resist for transfer of the circuit pattern. Subsequently, the semiconductor wafer is subjected to an etching step and to a film forming step. By repeating this series of steps, including the exposing step, a desired circuit is formed on the semiconductor wafer.

FIG. 4 shows one example of an EUV exposure apparatus disclosed in, e.g., Japanese Patent Laid-Open No. 11-243052. A pattern formed on a reflection mask 1201 serving as an original plate is transferred onto a wafer 1205 serving as a substrate through a projection optical system 1204. This exposure apparatus comprises the reflection mask 1201, the projection optical system 1204 constituted by a reflection optical system, a mask stage 1202 for holding the reflection mask 1201, and a wafer stage 1206 for holding the wafer 1205. An EUV (Extreme Ultra-Violet) light having an oscillation spectrum in a wavelength range of 5 to 15 nm (soft X-ray region) is used as the exposure light.

Such an EUV exposure apparatus is required to have not only high synchronization accuracy between the mask stage and the wafer stage for reliable scan exposure, but must also have high throughput.

One factor impeding the stage performance of each of the mask stage and the wafer stage is deformation of the structure caused by heat. Even when a wafer support member and a mask support member constituting parts of the respective stages are each formed of a material exhibiting low thermal expansion, such as SiC, the stage performance is potentially affected unless temperature control is performed at an accuracy level of not larger than 0.001° C. Also, when the wafer and the mask are moved at a high acceleration for the purpose of a higher throughput, heat generated by an electromagnetic motor, e.g., a linear motor for driving the stage, gives rise to a problem. If the stage acceleration is doubled, the generated heat is increased four times because it is in proportion to the square of acceleration. The electromagnetic motor for moving the wafer or the mask over a large stroke is responsible for 90% or more of the heat generated in each stage.

As compared with an apparatus for projecting and exposing a mask pattern to a wafer in air or an inert gas, e.g., nitrogen, the EUV exposure apparatus is advantageous in that, because of projecting and exposing a mask pattern to a wafer in a vacuum, the heat generated from coils of the electromagnetic motor is not transmitted to the mask stage or the wafer stage through the air or the inert gas. In the EUV exposure apparatus, if the heat generated from coils of the electromagnetic motor is avoided from being transmitted to apparatus components, such as a surface plate, through members supporting the mask stage or the wafer stage, there is no necessity of preventing the heat generation from the coils of the electromagnetic motor in order to eliminate an adverse effect upon the stage performance.

However, the above-mentioned advantage of the heat generated from the coils of the electromagnetic motor not being transmitted to the mask stage or to the wafer stage because of the employment of a vacuum means, on the other hand, that the heat generated from the coils of the electromagnetic motor will accumulate in the electromagnetic motor itself. Accordingly, there occurs a problem that the coils of the electromagnetic motor may suffer overheat damage from the heat generated by the coils themselves.

### SUMMARY OF THE INVENTION

It is an object of the present invention to provide an EUV exposure apparatus in which the coils of an electromagnetic motor for driving a stage do not suffer overheat damage from heat generated by the coils themselves.

To achieve the above and other objects, the present invention provides an EUV exposure apparatus for exposing a pattern of an original plate on an original plate stage to a substrate on a substrate stage in a vacuum, the apparatus comprising an electromagnetic motor disposed in the vacuum and driving at least one of the original plate stage and the substrate stage; and a cooling unit for cooling the electromagnetic motor to prevent overheat damage of the electromagnetic motor caused by heat generated by the electromagnetic motor.

According to the present invention having the features mentioned above, the EUV exposure apparatus enables exposure to be carried out with high accuracy while preventing overheat damage to the electromagnetic motor.

Preferably, overheat damage is prevented by cooling the electromagnetic motor while circulating a coolant. If the coolant is set to have a temperature lower than that of a wafer or a mask, a flow rate of the coolant can be reduced.

By separating the mask and/or the wafer and a support member for at least one of them from the heat generating portion of the electromagnetic motor in a non-contact relation, heat from the heat generating portion is kept from being transmitted to the wafer or the mask.

By providing a fine movement mechanism capable of driving the mask stage and/or the wafer stage by utilizing electromagnetic forces and thus without contact, heat of the stage is kept from being transmitted to the wafer or the mask. The fine movement mechanism is preferably supported by the stage in a non-contact manner.

Preferably, the heat generating portion of the electromagnetic motor is separated in a non-contact manner from at least one of a guide (e.g., a surface plate) for the mask stage and/or the wafer stage, a measuring device for measuring a position of the mask stage and/or the wafer stage, an optical system for adjusting an EUV exposure light, and a chamber for maintaining the exposure atmosphere therein. With this feature, the heat generated from the electromagnetic motor is prevented from being transmitted to a system affecting the exposure accuracy.

By arranging a measuring optical path of an interferometer system for measuring a position of the wafer and/or the mask in the vacuum, fluctuation error in the position measurement is eliminated and hence a limitation on an allowable surface temperature of the electromagnetic motor is greatly moderated.

In addition, by manufacturing a semiconductor device by employing the EUV exposure apparatus of the present invention, a device having a high packing density can be produced with a high throughput.

Further objects, features and advantages of the present invention will become apparent from the following description of the preferred embodiments with reference to the attached drawings.

### BRIEF DESCRIPTION OF THE DRAWINGS

FIG. 1 is a schematic view showing one embodiment of an EUV exposure apparatus according to the present invention.

FIG. 2 is a perspective view of a water stage employed in the embodiment shown in FIG. 1.

FIG. 3 shows a detailed structure of a linear motor.

FIG. 4 is a schematic view of a conventional EUV exposure apparatus.

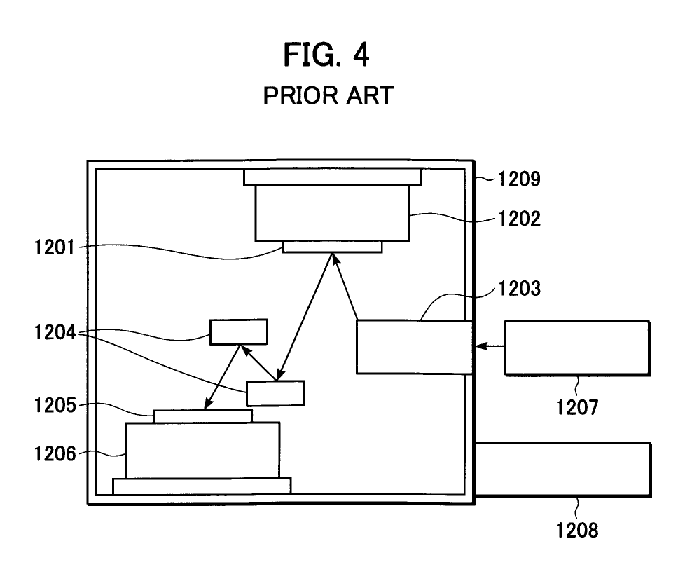

FIG. 5 is a flowchart showing an overall manufacturing process of a semiconductor device.

### DESCRIPTION OF THE PREFERRED EMBODIMENTS

One embodiment of the present invention will be described below with reference to the drawings.

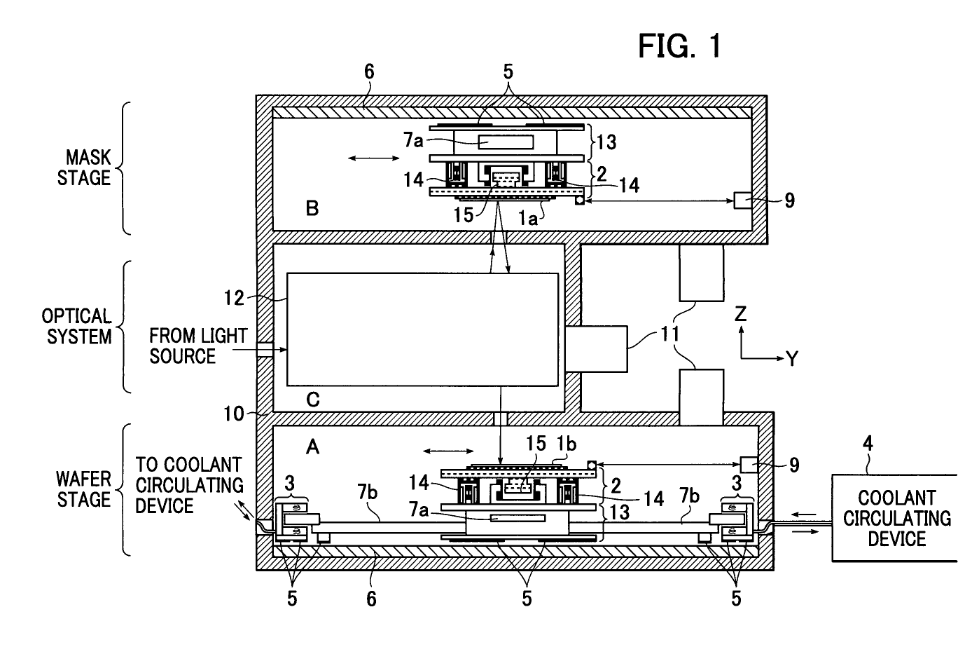

FIG. 1 is a schematic view for explaining the construction of an EUV exposure apparatus according to the present invention. The EUV exposure apparatus of this embodiment is a so-called step-and-scan exposure apparatus in which step movement between shot regions on a wafer and scan exposure within each shot region are repeated to carry out exposure of each shot region on the wafer. The EUV exposure apparatus is divided into a wafer stage section A, an optical system section C constituted by an optical system 12, and a mask stage section B. These sections are disposed in respective divided zones of a vacuum chamber 10 in which a vacuum is maintained, and the interior of each zone of the vacuum chamber 10 is held at a high vacuum by a corresponding vacuum pump 11.

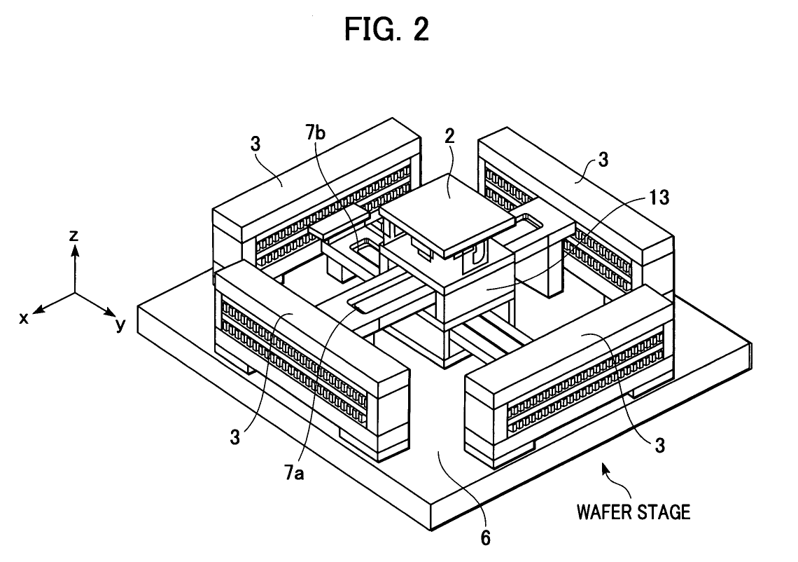

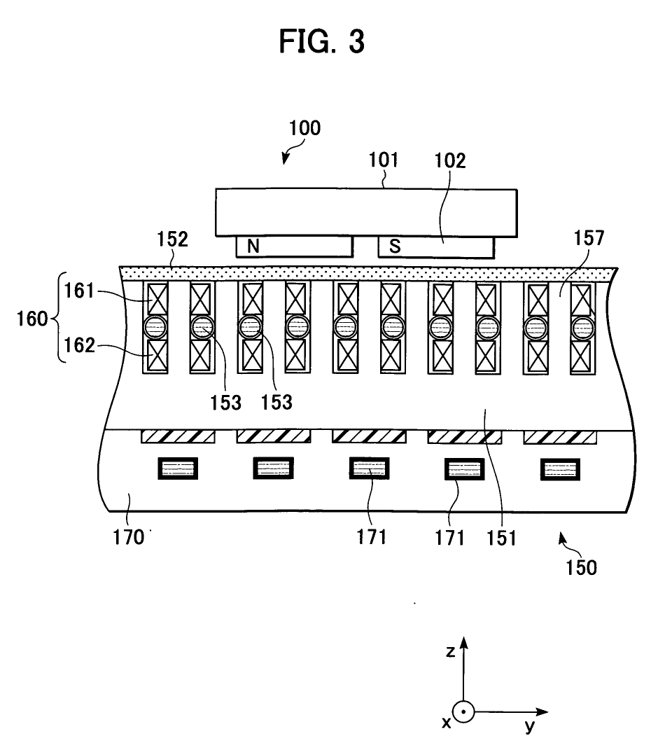

A wafer stage shown in FIG. 2 will be described with reference to FIGS. 1 and 3. In the wafer stage shown in FIG. 2, forces generated by Y-linear motors 3 constituted by electromagnetic motors are transmitted through a Y-slider 7a to move an XY-slider 13 on a stage surface plate 6 in the direction of a Y-axis, and forces generated by X-linear motors 3 constituted by electromagnetic motors are transmitted through an X-slider 7b to move the XY-slider 13 on the stage surface plate 6 in the direction of an X-axis (FIG. 1 shows the wafer stage in a direction perpendicular to the X-axis).

A stage 2 finely movable in 6-axis directions (X-axis, Y-axis, Z-axis, and rotating direction about each of the XYZ axes) is disposed on the wafer stage so that a semiconductor wafer 1b as a substrate held on the finely movable stage 2 can be positioned in the 6-axis directions with high accuracy. The finely movable stage 2 is provided with linear motors 14 (only part of which is shown) constituted by electromagnetic motors for fine positioning and is also provided with electromagnetic joints 15 for transmitting forces when the wafer stage is accelerated or decelerated. Thus, the wafer 1b can be moved in a non-contact relation to the XY-slider 13.

Members of the finely movable stage 2 on the side nearer to the wafer 1b are supported relative to members of the finely movable stage 2 on the side nearer to the XY-slider 13 in a non-contact relation to each other through a magnetically repulsing support mechanism in which a spring property is negligible. With the provision of such a mechanism, disturbance vibrations, etc. are shut off from entering the members (positioning section) of the finely movable stage 2 on the side nearer to the wafer 1b.

As shown in FIG. 3, each linear motor 3 comprises a stator 150 which includes coils, and a mover 100 which is coupled to the slider 7 (Y-slider 7a or X-slider 7b) and includes magnets 102. The stator 150 and the mover 100 are separated from each other in a non-contact relation. The stator 150 is guided relative to the surface plate 6 in a non-contact manner with the aid of vacuum static-pressure pads 5 shown in FIG. 1 such that the stator is moved while absorbing reaction forces generated by the linear motor 3.

The Y-slider 7a or the X-slider 7b coupled to the mover 100 is guided in a non-contact relation to the surface plate 6 with the aid of the vacuum static-pressure pads 5, and is also guided in a non-contact relation to the XY-slider 13 with the aid of electromagnetic guides not shown. Further, the XY-slider 13 is guided in a non-contact relation to the surface plate 6 with the aid of the vacuum static-pressure pads 5. In this embodiment, main structures of the wafer stage are all in a floating state in non-contact relation to each other.

A description will now be made of the mask stage. The mask stage is basically constructed in a vertical reversed relation to the wafer stage, and has a similar structure as the wafer stage in a point that the mask stage can also be positioned in the 6-axis directions. However, the mask stage does not include a structure corresponding to the X-linear motors 3 and the X-slider 7b, and is movable in the X-direction only within a stroke range of a 6-axis finely movable stage 2. Stated another way, in the scanning and exposing steps, the mask stage can be moved in the direction of the Y-axis by a small stroke driving mechanism combined with a large stroke driving mechanism not shown, and can be moved in the direction of the X-axis only by a small stroke driving mechanism.

With the wafer stage and the mask stage each having a multi-axis construction as described above, both stages can be positioned with higher accuracy and a greater degree of freedom, and they are flexibly adaptable for, e.g., synchronization errors in the scanning and exposing steps. It is also possible to flexibly compensate for a transfer error (e.g., a shift of the position where the substrate is placed) of the mask la or the wafer 1b caused upon transfer from a corresponding transport system.

Because the linear motors 3 of the wafer stage and the mask stage are installed in the vacuum held within the vacuum chamber 10, heat generated by upper and lower coils 161, 162 constituting a coil unit 160 shown in FIG. 3 cannot be transmitted for dissipation through air or an inert gas. Such a construction is advantageous in that the heat generated by the coils 161, 162 are prevented from being transmitted to the wafer stage and the mask stage through the air or the inert gas, while this feature gives rise to a new problem that the accumulated heat may cause an overheat damage of the coils 161, 162.

In the EUV exposure apparatus of this embodiment, therefore, the coil unit 160 must be cooled to an extent sufficient to avoid damage to the coils 161, 162, not for the purpose of preventing heat transmission from the linear motor 3 to the surroundings thereof, but for protecting the coil unit 160 against overheat damage. To realize that purpose, in the EUV exposure apparatus of this embodiment, each of the linear motors 3 for the wafer stage and the mask stage is cooled by circulating a coolant through the stator of the linear motor 3 using a coolant circulating device 4 as shown in FIG. 1. Note that a part of the stator of the linear motor 3 on the wafer stage side and the stator of the linear motor 3 on the mask stage side are not shown.

FIG. 3 shows a detailed structure of the linear motor 3. The linear motor 3 comprises two components, i.e., the mover 100 constituted by a moving yoke 101 having field permanent magnets 102, and the stator 150 constituted by core teeth 157 in which the coil unit 160 comprising the coils 161, 162 and first cooling pipes 153 is assembled. The mover 100 and the stator 150 are guided relative to the surface plate 6 independently of each other, and are separated from each other in a non-contact relation while holding a certain gap between them. A stator yoke 151 is fixed to a stator mount base 170 in which second cooling pipes 171 are arranged. Then, as shown in FIG. 1, the stator mount base 170 is guided in a non-contact relation to the surface plate 6 with the aid of the vacuum static-pressure pads 5.

The linear motor 3 shown in FIG. 3 is able to function alone as a driving device. In this embodiment, however, as shown in FIG. 2, two linear motors 3 are arranged in vertically opposed relation in the direction of the Z-axis and further arranging the field permanent magnets 102 on each of upper and lower surfaces of one moving yoke 101 for the purpose of increasing the constant of propulsion.

Because the stator yoke 151 is disposed in the vacuum and is thermally shut off from the other components including the mask stage and the wafer stage (specifically the positioning members), it can be considered that the coil unit 160 as a source of generating heat in the stator yoke 151 will hardly impose a thermal effect to the surroundings. In the EUV exposure apparatus of this embodiment, not only the stator 150, but also most of the other structural members are guided in a non-contact manner in the vacuum as described above, and therefore they can be said as being in a thermally insulated state.

Further, in the EUV exposure apparatus of this embodiment, because a position measuring optical path of a laser interferometer 9, which serves as a range finder for measuring the position of the mask stage or the wafer stage on the XYZ-coordinate system, is defined in the vacuum, there is no need to prevent the heat generation from the linear motor 3 for eliminating a fluctuation component otherwise occurred in an output of the laser interferometer 9.

For that reason, the EUV exposure apparatus of this embodiment is free of the necessity of cooling with such a high accuracy as controlling the surface temperature of the stator 150 at a level of 1/1000° C. to 1/10° C., which has been required in the past in conventional apparatus in which exposure is performed in air or an inert gas. Hence, the coolant circulating device 4 and so on may be a very simple and uncomplicated structure. As a matter course, the cooling may be performed at such high accuracy as controlling the surface temperature of the stator 150 at a level of 1/1000° C. to 1/10° C., but the highly accurate cooling is of no practical value.

Stated another way, in the EUV exposure apparatus of this embodiment, the coolant circulating device 4 is required only to prevent overheat of the linear motor. By cooling the linear motor such that a maximum temperature of the coils 161, 162 is held at, e.g., about 80° C. (or not higher than 80° C.), temperature changes of the mask 1a, the wafer 1b, and the mask and wafer stages as members for supporting them can be each held to 1/1000° C. or less. As a result, the coolant circulating device 4 can be noticeably simplified.

In the conventional apparatus in which exposure is performed in air or an inert gas, the coolant temperature has been set equal to the wafer temperature so that an object to be cooled is managed to be held at the wafer temperature. By contrast, in the EUV exposure apparatus of this embodiment, since the temperature of the stator yoke 151 does not affect the other components, the coolant temperature can be set lower than the wafer temperature. This increases flexibility in the selection of a cooling method.

While the respective linear motors 3 of the mask stage and the wafer stage are cooled in this embodiment, the linear motors 3 may be cooled, as required, for only one of the mask stage and the wafer stage.

Also, while this embodiment employs a construction in which the respective linear motors 3 of the mask stage and the wafer stage are arranged in the vacuum inside the chamber 10, the present invention is not limited to such a construction. The linear motors 3 for either one of the mask stage and the wafer stage may be arranged outside the chamber 10. In that case, the coolant may be circulated from the coolant circulating device 4 to at least the linear motors 3 for the stage arranged inside the chamber 10.

Further, in addition to the EUV exposure apparatus, the present invention is also applicable to, for example, an EB exposure apparatus for projecting and exposing a pattern onto a semiconductor wafer as a substrate in a vacuum with an electron beam.

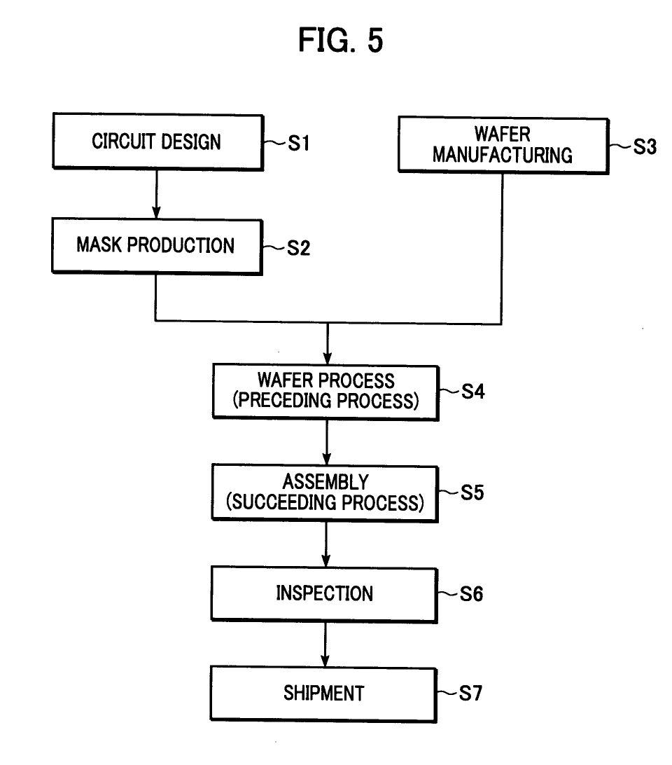

A description is now made of a manufacturing process of a semiconductor device utilizing the EUV exposure apparatus of the present invention. FIG. 5 is a flowchart showing the manufacturing process of a semiconductor device. In step SI (circuit design), circuit design of the semiconductor device is carried out. In step S2 (mask production), a mask is manufactured in accordance with a designed circuit pattern.

On the other hand, in step S3 (wafer manufacturing), a wafer is manufactured using silicon or a similar material. Step S4 (wafer process) is called a preceding process in which, using the mask and the wafer thus prepared, an actual circuit is formed on the wafer with the photolithography by employing the exposure apparatus described above. Next step S5 (assembly) is called a succeeding process in which a semiconductor chip is formed using the wafer prepared in step S4. Step S5 includes assembling steps (such as dicing and bonding) and a packaging step (chip sealing). In step S6 (inspection), a semiconductor device prepared in step S5 is subjected to inspection including an operation confirming test and a durability test. The semiconductor device is completed through the steps mentioned above and is shipped in Step S7.

The wafer process in Step S4 comprises an oxidation step of oxidizing the surface of a wafer, a CVD step of forming an insulating film on the wafer surface, an electrode forming step of forming electrodes on the wafer by vapor deposition, an ion implanting step of implanting ions into the wafer, a resist processing step of coating a photosensitive agent on the wafer, an exposure step of transferring a circuit pattern onto the wafer after the resist processing step by employing the exposure apparatus described above, a development step of developing the circuit pattern on the wafer exposed in the exposure step, an etching step of etching away portions other than a resist image developed in the development step, and a resist peeling-off step of removing a resist left after the etching. The circuit pattern is formed on the wafer in multiple layers by repeating those steps.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims.

What is claimed is:

1. An EUV exposure apparatus for scanning and exposing a pattern of an original plate to a substrate in a vacuum, the apparatus comprising:
an original plate stage for moving the original plate;
a substrate stage for moving the substrate;
an electromagnetic motor disposed in the vacuum and driving at least one of the original plate stage and the substrate stage; and
cooling means for cooling said electromagnetic motor an amount sufficient to prevent overheat damage of said electromagnetic motor resulting from heat generated by said electromagnetic motor.

2. An EUV exposure apparatus according to claim 1, wherein said cooling means cools said electromagnetic motor by circulating a coolant.

3. An EUV exposure apparatus according to claim 2, wherein said coolant has a temperature lower than a temperature of at least one of the original plate and the substrate.

4. An EUV exposure apparatus according to claim 1, wherein at least one of the original plate stage and the substrate stage is out of contact with a heat generating portion of said electromagnetic motor.

5. An EUV exposure apparatus according to claim 4, wherein at least one of the original plate stage and the substrate stage includes a fine movement mechanism for driving the at least one of the original plate and the substrate in a non-contact manner by utilizing electromagnetic forces.

6. An EUV exposure apparatus according to claim 5, wherein said fine movement mechanism is supported to for driving the original plate stage or the substrate stage in a non-contact manner.

7. An EUV exposure apparatus according to claim 1, wherein a heat generating portion of said electromagnetic motor is out of contact with at least one of a guide for at least one of the original plate stage and the substrate stage, a measuring device for measuring a position of at least one of the original plate stage and the substrate stage, an optical system for adjusting an EUV exposure light, and a chamber for maintaining the vacuum therein.

8. An EUV exposure apparatus according to claim 1, wherein a measuring optical path of said measuring device for measuring a position of at least one of the original plate stage and the substrate stage is disposed in the vacuum.

9. An exposure apparatus for exposing a pattern to a substrate in a vacuum, the apparatus comprising:
a substrate stage for moving said substrate;
an electromagnetic motor disposed in the vacuum and driving said substrate stage; and
cooling means for cooling said electromagnetic motor an amount sufficient to prevent overheat damage to said electromagnetic motor caused by heat generated by said electromagnetic motor.

10. A device manufacturing method comprising the steps of:
preparing an exposure apparatus according to any one of claims 1 to 9, and exposing a pattern to a substrate by employing said exposure apparatus.
